(19) United States
(12) Patent Application Publication
(10) Pub. No.: US 2026/0040139 A1
(43) Pub. Date: Feb. 5, 2026

(54) METHOD OF PACKET DATA CONVERGENCE PROTOCOL DISCARD MANAGEMENT AND USER EQUIPMENT USING THE SAME

(71) Applicant: Industrial Technology Research Institute, Hsinchu (TW)

(72) Inventors: Tzu-Jane Tsai, Hsinchu County (TW); Chun-Yuan Chiu, Pingtung County (TW); Fang-Ching Ren, Hsinchu City (TW)

(73) Assignee: Industrial Technology Research Institute, Hsinchu (TW)

(21) Appl. No.: 19/284,679

(22) Filed: Jul. 30, 2025

Related U.S. Application Data
(60) Provisional application No. 63/678,065, filed on Aug. 1, 2024.
(60) Provisional application No. 63/730,966, filed on Dec. 12, 2024.

(51) Int. Cl. H04W 28/06; H04L 1/1607; H04W 80/02

(52) U.S. Cl. CPC H04W 28/06; H04L 1/1614; H04W 80/02

(57) ABSTRACT

A method of packet data convergence protocol (PDCP) discard management and a user equipment are provided. The method includes: obtaining a plurality of PDCP service data units (SDUs), wherein the plurality of PDCP SDUs comprises a first PDCP SDU corresponding to a first parameter and a second PDCP SDU corresponding to a second parameter; setting a discard timer for the first PDCP SDU according to a radio resource control configuration received from a base station; discarding the first PDCP SDU after the discard timer has expired and determining whether the second parameter is the same as the first parameter; and in response to the second parameter being the same as the first parameter, discarding the second PDCP SDU.

### CROSS-REFERENCE TO RELATED APPLICATION

This application claims the priority benefit of U.S. provisional application Ser. No. 63/678,065, filed on Aug. 1, 2024 and U.S. provisional application Ser. No. 63/730,966, filed on Dec. 12, 2024. The entirety of each of the above-mentioned patent applications is hereby incorporated by reference herein and made a part of this specification.

### BACKGROUND

### Technical Field

The disclosure is directed to a method of packet data convergence protocol (PDCP) discard management and a user equipment (UE) using the same method.

### Description of Related Art

Multi-modal data of multi-modal communication services is defined to describe the input data from different kinds of devices/sensors or the output data to different kinds of destinations (e.g., one or more UEs) required for the same task or application. Multi-modal data consists of more than one single-modal data, and there is strong dependency among each single-modal data, wherein a single-modal data can be seen as one type of data (e.g., data corresponding to the same traffic type). For immersive multi-modal virtual reality (VR) applications, synchronization between different media components is critical to ensuring a seamless user experience. A lack of synchronization can negatively impact user perception, particularly when the synchronization threshold between multiple modalities is lower than the latency key performance indicator (KPI) of the applications. Therefore, achieving precise synchronization of multi-modal data corresponding to the same service is a crucial challenge.

### SUMMARY

The disclosure is directed to a method of PDCP discard management and a UE using the same method. The disclosure may avoid unnecessary transmissions of obsolete data.

The present disclosure is directed to a method of packet data convergence protocol (PDCP) discard management, suitable for a user equipment. The method includes: obtaining a plurality of PDCP service data units (SDUs), wherein the plurality of PDCP SDUs includes a first PDCP SDU corresponding to a first parameter and a second PDCP SDU corresponding to a second parameter; setting a discard timer for the first PDCP SDU according to a radio resource control configuration received from a base station; discarding the first PDCP SDU after the discard timer has expired and determining whether the second parameter is the same as the first parameter; and in response to the second parameter being the same as the first parameter, discarding the second PDCP SDU.

The present disclosure is directed to a user equipment including a transceiver and a processor. The transceiver receives a radio resource control configuration from a base station. The processor is coupled to the transceiver and configured to: obtain a plurality of packet data convergence protocol (PDCP) service data units (SDUs), wherein the plurality of PDCP SDUs comprises a first PDCP SDU corresponding to a first parameter and a second PDCP SDU corresponding to a second parameter; set a discard timer for the first PDCP SDU according to the radio resource control configuration; discard the first PDCP SDU after the discard timer has expired and determine whether the second parameter is the same as the first parameter; and in response to the second parameter being the same as the first parameter, discard the second PDCP SDU.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 illustrates a schematic diagram of multi-modal data according to one embodiment of the present disclosure.

FIG. 2 illustrates a schematic diagram of mapping alternatives of QoS flow according to one embodiment of the present disclosure.

FIG. 3 illustrates a signaling diagram of enhancement of PDCP discard for multi-modal synchronization according to one embodiment of the present disclosure.

FIG. 4 illustrates a schematic diagram of inter-DRB PDCP discard based on a MMSID according to one embodiment of the present disclosure.

FIG. 5 illustrates a schematic diagram of intra-DRB PDCP discard based on a MMSID according to one embodiment of the present disclosure.

FIG. 6 illustrates a flowchart of a method of PDCP discard management according to one embodiment of the present disclosure.

FIG. 7 illustrates a schematic diagram of a communication device according to one embodiment of the present disclosure.

### DESCRIPTION OF THE EMBODIMENTS

Multi-modal data consists of more than one type of data, where there is strong dependency among different types of data. To maintain the dependency of the multi-modal data, the multi-modal data may be proceeded using a single quality of service (QoS) flow or multiple QoS flows. A single QoS flow can maintain the dependency of the multi-modal data easily, but may lose QoS control granularity. Multiple QoS flows can provide a better QoS control granularity, but additional efforts are required to maintain the dependency for inter flow data.

Immersive multi-modal VR application describes the case of a human interacting with virtual entities in a remote environment such that the perception of interaction with a real physical world is achieved. As the asynchrony between different modalities increases, user's sense of presence and realism will decrease. Multi-modal synchronization threshold can be defined as the maximum tolerable temporal separation of two stimuli in the same data burst (or ONSET, packet data unit (PDU) set), wherein one of the stimuli is presented to one sense and the other to another sense, such that the accompanying sensory objects are perceived as being synchronous. Different type SDUs belong to the same data burst (or ONSET, PDU set) are expected to be received without exceed the synchronization threshold.

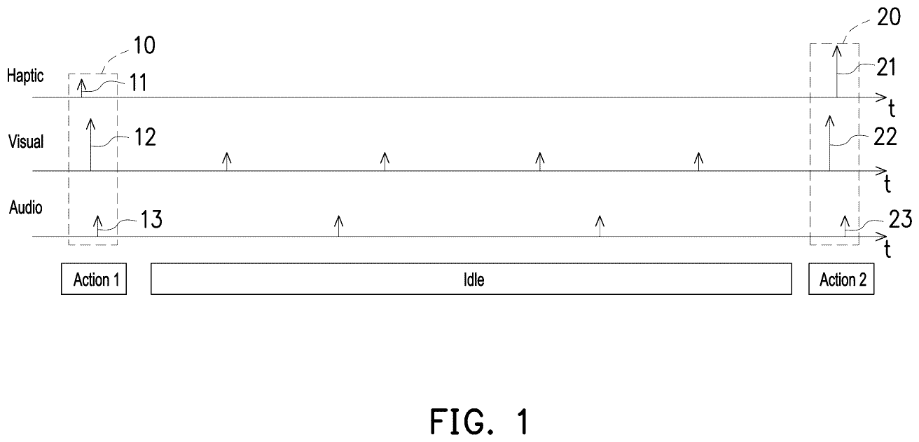

FIG. 1 illustrates a schematic diagram of multi-modal data according to one embodiment of the present disclosure. Assume that the data burst 10 includes the service data unit (SDU) 11 corresponding to the haptic traffic flow, the SDU 12 corresponding to the visual traffic flow, and the SDU 13 corresponding to the audio traffic flow, and the data burst 20 includes the SDU 21 corresponding to the haptic traffic flow, the SDU 22 corresponding to the visual traffic flow, and the SDU 23 corresponding to the audio traffic flow. The latencies between the SDU 11, SDU 12, and SDU 13 are expected to be lower than synchronization threshold since these SDUs belong to the same data burst.

For multi-modal extended reality (XR) applications, radio access network (RAN) becomes a bottleneck in the multi-modal synchronization. Haptic data requires very stringent delay budget and the burst size or periodicity of data bursts of a multi-modal service can be unpredictable and irregular. For example, the data burst 10 can be generated after Action 1 is performed by a user. It is hard to predict when will the user perform Action 2 or when will the data burst 20 be generated. When the user stays idle, some data (e.g., visual traffic or audio traffic as shown in FIG. 1) uncorrelated with any actions may be detected. Because the RAN currently does not have multi-modal awareness, the logical channel prioritization (LCP) allocates resources in a decreasing logical channel (LCH) priority order and cannot support the multi-modal synchronization. That is, the LCP cannot make an appropriate medium access control (MAC) PDU for multi-modal synchronization. Therefore, an enhancement of PDCP discard management to avoid unnecessary transmissions of obsolete data is needed.

From the point of view of the RAN, data that are related in time will only be in one data burst. A synchronized burst is composed with more than one SDUs from dependent QoS flows. It is reasonable to assume that the interval between a synchronized burst and the subsequent synchronized burst will be much larger than the synchronization threshold of the dependent data. That is, for two adjacent synchronized bursts, the probability that their respective SDUs (or PDUs) exist in a UE's packet data convergence protocol (PDCP) buffer at the same time is very low. Take FIG. 1 as an example, the interval between the data burst 10 and the data burst 20 can be much larger than the synchronization threshold. The probability that SDU 11 (or SDU 12, SDU 13) and SDU 21 (or SDU 22, SDU 23) in the UE's buffer in the same time is very low.

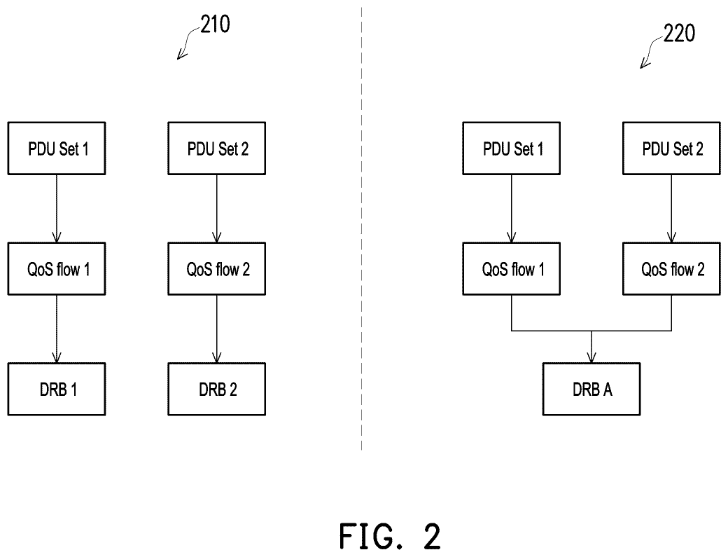

FIG. 2 illustrates a schematic diagram of mapping alternatives of QoS flow according to one embodiment of the present disclosure. In mapping alternative 210, the ratio of the number of QoS flows and the number of data radio bearers (DRBs) can be 1:1, wherein each QoS flow may be mapped to a corresponding DRB (i.e., PDCP entity). For example, the QoS flow 1 corresponding to the PDU set 1 and the QoS flow 2 corresponding to the PDU set 2 can be transmitted via different DRBs (e.g., DRB 1 and DRB 2) respectively. In mapping alternative 220, the ratio of the number of QoS flows and the number of DRBs can be N:1, where N is a positive integer greater than 1. For example, the QoS flow 1 corresponding to the PDU set 1 and the QoS flow 2 corresponding to the PDU set 2 can be transmitted via the same DRB (e.g., DRB A).

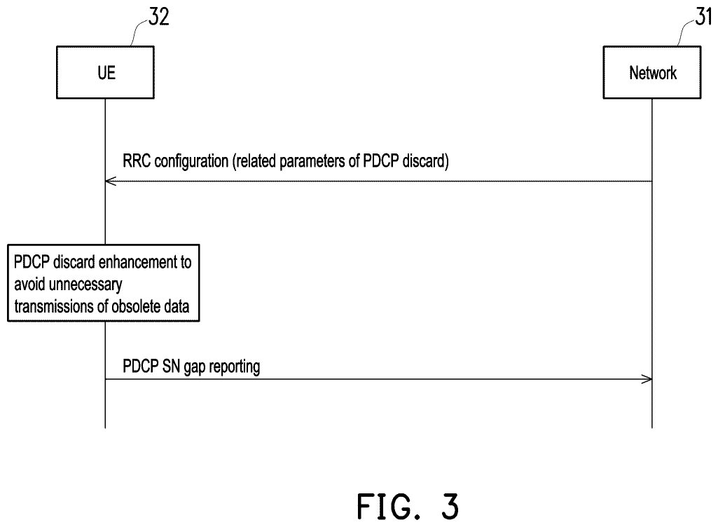

FIG. 3 illustrates a signaling diagram of enhancement of PDCP discard for multi-modal (MM) synchronization according to one embodiment of the present disclosure. Network 31 (e.g., a next generation radio access network (NG-RAN) or a base station (BS)) may transmit a radio resource control (RRC) configuration to UE 32. The RRC configuration may include parameters related to PDCP discard. An entity of UE 32 (e.g., PDCP entity) may perform PDCP discard enhancement to avoid unnecessary transmissions of obsolete data. The PDCP serial number (SN) gap reporting may be transmitted to Network 31 after a PDCP discard enhancement is performed.

For example, UE 32 may receive a multi-modal discard indication from network 31 and perform PDCP discard based on the multi-modal discard indication, wherein the multi-modal discard indication may include a new downlink control information (DCI), a medium access control (MAC) control element (CE), or a PDCP control PDU. For example, UE 32 may perform PDCP discard based on a multi-modal service identifier (MMSID) configured via an RRC configuration. For example, UE 32 may reuse PDU set importance (PSI) based SDU discard activation/deactivation MAC CE to perform PDCP discard.

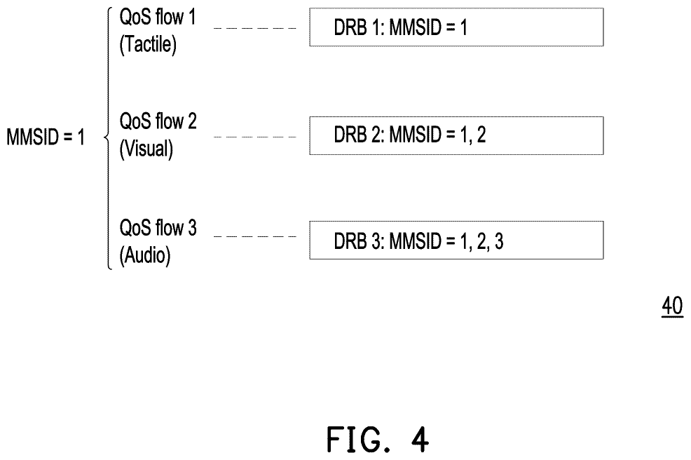

FIG. 4 illustrates a schematic diagram 40 of inter-DRB PDCP discard based on a MMSID according to one embodiment of the present disclosure. One or more entities (e.g., PDCP entities) of a UE may obtain a plurality of QoS flows (or data flows, DRBs, PDCP SDUs) from upper layer (e.g., service data adaptation protocol (SDAP) layer) of the UE. For example, a plurality of PDCP entities of a UE may obtain QoS flow 1 corresponding to tactile data, QoS flow 2 corresponding to visual data, and QoS flow 3 corresponding to audio data respectively. Each QoS flow to be transmitted can be stored in a buffer (e.g., PDCP buffer) of the UE. After receiving an uplink (UL) grant from the network, the UE may perform LCP based on the UL grant to select a QoS flow to be transmitted first (i.e., the QoS flow with the highest logical channel priority) based on the result of the LCP.

In response to obtaining a QoS flow (e.g., from upper layer), a discard timer (e.g., discardTimer) for the PDCP SDU in the QoS flow may be set/reset by the PDCP entity, wherein the discard timer can be configured to the UE from the network via a RRC configuration. The UE may transmit the PDCP SDU in the selected QoS flow before the discard timer expires. For example, the UE may transmit QoS flow 1, QoS flow 2, or QoS flow 3 to the network via multiple DRBs (e.g., DRB 1, DRB 2, or DRB 3) respectively if the discard timer for each PDCP SDU in the QoS flow does not expire, wherein the multiple DRBs may respectively correspond to different PDCP entities of the UE. However, if the PDCP SDU in the QoS flow has not been transmitted before the corresponding discard timer expires, the PDCP entity may discard the PDCP SDU in the QoS flow from the PDCP buffer.

Assume that the UE selects QoS flow 1 as the QoS flow to be transmitted first, QoS flow 1 includes one or more PDCP SDUs corresponding to MMSID 1 which are tactile data, QoS flow 2 includes one or more PDCP SDUs corresponding to MMSID 1 which are visual data, and QoS flow 3 includes one or more PDCP SDUs corresponding to MMSID 1 which are audio data. In FIG. 4, only QoS flow 1 with MMSID 1 is mapped to DRB 1, QoS flow 2 with MMSID 1 and another QoS flow with MMSID 2 are mapped to DRB 2, QoS flow 3 with MMSID 1 and another two QoS flows with MMSID 2, MMSID 3 respectively are mapped to DRB 3. If a PDCP SDU in QoS flow 1 has not been transmitted by the UE before the discard timer of the PDCP SDU expires, the UE may discard the PDCP SDU in QoS flow 1 from the corresponding PDCP buffer after the discard timer expires. The UE may determine whether a parameter of a specific PDCP SDU stored in each PDCP entity is the same as the parameter of the PDCP SDU (i.e., the selected PDCP SDU) to be discarded, wherein the parameter may include a MMSID. If the parameter of the specific PDCP SDU is the same as the parameter of the selected PDCP SDU, the PDCP entity may discard the specific PDCP SDU from the corresponding PDCP buffer. Accordingly, unnecessary transmissions for the obsolete data can be avoided. For example, after the UE determines to discard a PDCP SDU with MMSID 1 in QoS flow 1, the UE may determine whether a PDCP SDU in QoS flow 2 or QoS flow 3 with the same MMSID (i.e., MMSID 1) exists in a PDCP buffer. If the PDCP SDU in QoS flow 2 or QoS flow 3 with MMSID 1 exists in a PDCP buffer, the PDCP entity of the UE may discard the PDCP SDU from the corresponding PDCP buffer.

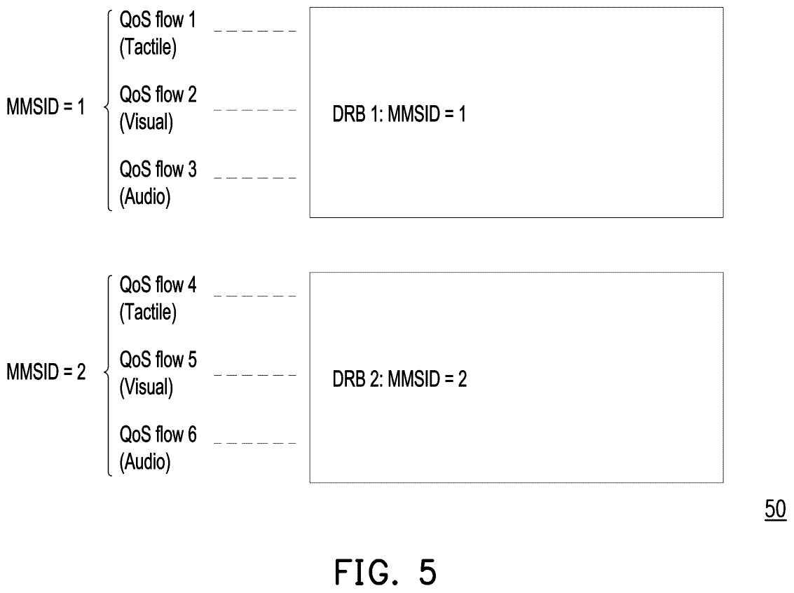

FIG. 5 illustrates a schematic diagram 50 of intra-DRB PDCP discard based on a MMSID according to one embodiment of the present disclosure. An entity (e.g., PDCP entity) of a UE may obtain a plurality of QoS flows (or data flows, DRBs, PDCP SDUs) from upper layer (e.g., SDAP layer) of the UE. For example, a PDCP entity corresponding to DRB 1 of the UE may obtain QoS flow 1 corresponding to tactile data, QoS flow 2 corresponding to visual data, and QoS flow 3 corresponding to audio data, and the other PDCP entity corresponding to DRB 2 of the UE may obtain QoS flow 4 corresponding to tactile data, QoS flow 5 corresponding to visual data, and QoS flow 6 corresponding to audio data. Each QoS flow to be transmitted can be stored in a buffer (e.g., PDCP buffer) of the UE. After receiving an UL grant from the network, the UE may perform LCP based on the UL grant to select a QoS flow to be transmitted first (i.e., the QoS flow with the higher logical channel priority) based on the result of the LCP.

In response to obtain a QoS flow (e.g., from upper layer), a discard timer (e.g., discardTimer) for the PDCP SDU in the QoS flow may be set/reset by the PDCP entity, wherein the discard timer can be configured to the UE from the network via a RRC configuration. The UE may transmit the PDCP SDU in the selected QoS flow before the discard timer expires. For example, the UE may transmit QoS flows 1-3 and QoS flows 4-6 to the network via multiple DRBs (e.g., DRB 1 or DRB 2) respectively if the discard timer for each PDCP SDU in the QoS flow does not expires, wherein one DRB may correspond to one PDCP entity of the UE. For example, QoS flows 1-3 to be transmitted via one DRB (i.e., DRB 1) may belong to one PDCP entity. QoS flows 4-6 to be transmitted via one DRB (i.e., DRB 2) may belong to one PDCP entity. However, if the PDCP SDU in the QoS flow has not been transmitted before the corresponding discard timer expires, the PDCP entity may discard the PDCP SDU in the QoS flow from the PDCP buffer.

Assume that the UE selects QoS flow 1 as the QoS flow to be transmitted first, QoS flow 1 includes one or more PDCP SDUs corresponding to MMSID 1 which are tactile data, QoS flow 2 includes one or more PDCP SDUs corresponding to MMSID 1 which are visual data, and QoS flow 3 includes one or more PDCP SDUs corresponding to MMSID 1 which are audio data. In FIG. 5, QoS flow 1, 2 and 3 are all with MMSID 1 and mapped to DRB 1. If a PDCP SDU in QoS flow 1 has not been transmitted by the UE before the discard timer of the PDCP SDU expires, the UE may discard the PDCP SDU in QoS flow 1 from the corresponding PDCP buffer after the discard timer expires. The UE may determine whether a parameter of a specific PDCP SDU stored in the same PDCP entity is the same as the parameter of the selected PDCP SDU in QoS flow 1, wherein the parameter may include a MMSID. If the parameter of the specific PDCP SDU is the same as the parameter of the selected PDCP SDU, the PDCP entity may discard the specific PDCP SDU from the corresponding PDCP buffer. Accordingly, unnecessary transmissions for the obsolete data can be avoided. For example, after the UE determines to discard a PDCP SDU with MMSID 1 in QoS flow 1, the UE may determine whether a PDCP SDU corresponding to the same PDCP entity (e.g., the PDCP SDU in QoS flow 2 or QoS flow 3) has the same MMSID (i.e., MMSID 1). If the PDCP SDU in QoS flow 2 or QoS flow 3 with MMSID 1 exists in the same PDCP buffer, the corresponding PDCP entity of the UE may discard the PDCP SDU from the PDCP buffer.

In one embodiment, an entity (e.g., PDCP entity) of a UE may perform PDCP discard based on MMSID. When a discard timer of a PDCP SDU expires: if the MMSID of the PDCP SDU is set and the PDCP discard based on MMSID is activated or configured, the PDCP entity may discard the PDCP SDU and other (or the remaining) PDCP SDUs, wherein the other PDCP SDUs and the discarded PDCP SDU belong to the same MMSID. The other PDCP SDUs and the discarded PDCP SDU may belong to the same or different PDCP entities of the UE; else if the MMSID of the PDCP SDU is not set or the PDCP discard based on MMSID is not activated or configured, the PDCP entity may discard the PDCP SDU, and the other PDCP SDUs may be or may not be discarded by the PDCP entity. In one embodiment, a PDCP SN gap reporting may be activated or deactivated when the PDCP discard based on MMSID is activated or deactivated.

In one embodiment, an entity (e.g., PDCP entity) of a UE may perform PDCP discard based on MMSID and parameter pdu-SetDiscard (or content ratio, PDU set integrated handling indication (PSIHI)). When a discard timer of a PDCP SDU expires, the MMSID of the PDCP SDU is set, and the PDCP discard based on MMSID is activated or configured, the UE may check whether pdu-SetDiscard or pdu-SetDiscardthreshold is configured to the UE, or whether pdu-SetDiscardthreshold is reached: if parameter pdu-SetDiscard is configured for other (or the remaining) PDCP SDUs or threshold pdu-SetDiscardthreshold is configured and reached, the PDCP SDU and the other PDCP SDUs may be discarded at the UE, wherein the other PDCP SDUs and the discarded PDCP SDU belong to the same MMSID. The other PDCP SDUs and the discarded PDCP SDU may belong to the same or different PDCP entities of the UE; else if pdu-SetDiscard is not configured for the other PDCP SDUs or pdu-SetDiscardthreshold is not configured or reached, the PDCP SDU may be discarded, and the other PDCP SDUs may be or may not be discarded at the UE. PSIHI indicates whether all PDUs of the PDU set are needed for the usage of PDU set by application layer. The content ratio (e.g., pdu-SetDiscardthreshold) is defined as the ratio of PDUs of a PDU set that are needed at the UE to be able to reconstruct the original content.

In one embodiment, a BS may send a bitmap of the PDCP SDU discard indication based on the MMSID to a UE via a MAC CE, wherein the bitmap of the PDCP SDU discard indication based on the MMSID may indicate whether the PDCP SDU discard operation based on the MMSID for each of a plurality of DRBs is activated or deactivated.

In one embodiment a BS may send a PDCP SDU discard indication based on the MMSID to a UE via a PDCP control PDU or a DCI to a UE.

In one embodiment, an entity (e.g., PDCP entity) of a UE may perform PDCP SDU discard based on low-importance MMSID, wherein the UE may receive the indication of low-importance MMSID from the BS. A PDCP SDU can be regarded as unimportance if the PDCP SDU belongs to a low-importance MMSID. A low-importance MMSID may indicate that the importance of a PDCP SDU belonging to the low-importance MMSID is below to a threshold. When a discard timer of a PDCP SDU expires: if the low-importance MMSID of the PDCP SDU is set and the PDCP discard based on MMSID is activated or configured, the PDCP SDU and other (the remaining) PDCP SDUs may be discarded, wherein the other PDCP SDUs and the discarded PDCP SDU belong to the same MMSID (i.e., low-importance MMSID); else if low-importance MMSID of the PDCP SDU is not set or the PDCP discard based on MMSID is not activated or configured, the PDCP SDU may be discarded, and the other PDCP SDUs may be or may not be discarded. In one embodiment, identification of importance of a MMSID and determination of low-importance MMSID may be left up to UE implementation.

Two PDCP SDUs may be regarded as in the same burst if the time interval between the two PDCP SDUs is less than a time duration (e.g., a synchronization threshold). In one embodiment, an entity (e.g., PDCP entity) of a UE may perform PDCP discard based on MMSID and burst. When a discard timer of a PDCP SDU expires: if the MMSID of the PDCP SDU is set and the PDCP discard based on MMSID is activated or configured, the PDCP entity may discard the PDCP SDU and other (the remaining) PDCP SDUs, wherein the other PDCP SDUs and the discarded PDCP SDU belong to the same MMSID and the same burst; else if the MMSID of the PDCP SDU is not set or the PDCP discard based on MMSID is not activated or configured, the PDCP SDU may be discarded, and the other PDCP SDUs may be or may not be discarded. In one embodiment, identification of a burst of a MMSID may be left up to UE implementation. For example, the UE may determine whether PDCP SDUs belong to the same or different bursts based on a specific time threshold (e.g., synchronization threshold). If the time interval between the PDCP SDUs is less than or equal to the threshold, the UE may determine that the PDCP SDUs belong to the same burst. If the time interval is greater than the threshold, the UE may determine that the PDCP SDUs belong to different bursts respectively.

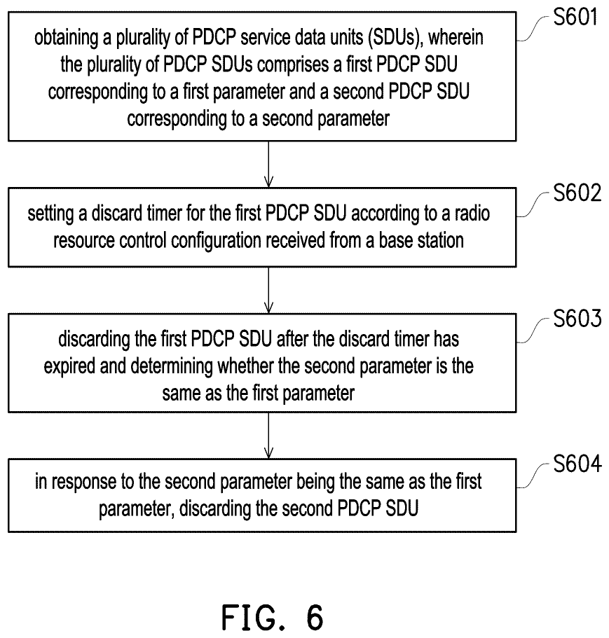

FIG. 6 illustrates a flowchart of a method of PDCP discard management according to one embodiment of the present disclosure, wherein the method can be implemented by a transmitting end (e.g., a PDCP entity of a UE). In step S601, obtaining a plurality of PDCP service data units (SDUs), wherein the plurality of PDCP SDUs comprises a first PDCP SDU corresponding to a first parameter and a second PDCP SDU corresponding to a second parameter. In step S602, setting a discard timer for the first PDCP SDU according to a radio resource control configuration received from a base station. In step S603, discarding the first PDCP SDU after the discard timer has expired and determining whether the second parameter is the same as the first parameter. In step S604, in response to the second parameter being the same as the first parameter, discarding the second PDCP SDU.

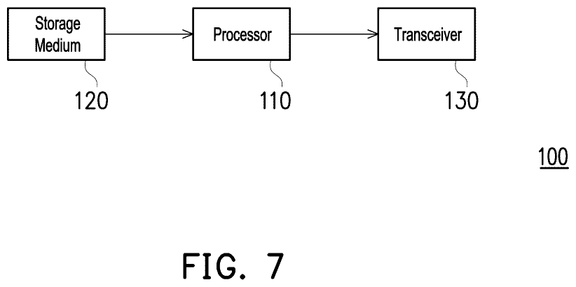

FIG. 7 illustrates a schematic diagram of a communication device 100 according to one embodiment of the present disclosure. The communication device 100 may include a processor 110, a storage medium 120, and a transceiver 130. The processor 110 is coupled to the storage medium 120 and the transceiver 130 and is configured to at least to implement the method as described in FIGS. 1-6 as well as its exemplary embodiment and alternative variations. In one embodiment, the communication device 100 may be implemented as the UE or the BS (e.g., network or network node) as mentioned above.

The processor 110 coupled be implemented by using programmable units such as a micro-processor, a micro-controller, a digital signal processor (DSP), a field programmable gate array (FPGA), etc. The functions of the processor 110 may also be implemented with separate electronic devices or ICs. It should be noted that functions of the processor 110 may be implemented with either hardware or software.

The storage medium 120 may be, for example, any type of fixed or removable random access memory (RAM), a read-only memory (ROM), a flash memory, a hard disc drive (HDD), a solid state drive (SSD) or similar element, or a combination thereof, configured to record a plurality of modules or various applications executable by the processor 110. The storage medium 120 may store a buffer (e.g., MAC buffer, RLC buffer, PDCP buffer, or SDAP buffer) or an entity (e.g., MAC entity, RLC entity, PDCP entity, or SDAP entity).

The transceiver 130 may be configured to transmit and receive signals respectively in the radio frequency. The transceiver 130 may also perform operations such as low noise amplifying, impedance matching, frequency mixing, up or down frequency conversion, filtering, amplifying, and so forth. The transceiver 130 may include one or more digital-to-analog (D/A) converters or analog-to-digital (A/D) converters which are configured to convert from an analog signal format to a digital signal format during uplink signal processor and from a digital signal format to an analog signal formant during downlink signal processing. The transceiver 130 may include an antenna array which may include one or more antennas to transmit and receive omni-directional antenna beams or directional antenna beams.

Based on the above, the disclosed UE may determine whether a set of PDCP SDU belong to the same parameter (e.g., MMSID). For the PDCP SDUs belonging to the same MMSID, if one of the PDCP SDUs is to be discarded by the UE (e.g., due to discard timer expiration), the UE may also discard the remaining PDCP SDUs associated with the same MMSID to avoid unnecessary transmissions for the obsolete data.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A method of packet data convergence protocol (PDCP) discard management, suitable for a user equipment, comprising:
obtaining a plurality of PDCP service data units (SDUs), wherein the plurality of PDCP SDUs comprises a first PDCP SDU corresponding to a first parameter and a second PDCP SDU corresponding to a second parameter;
setting a discard timer for the first PDCP SDU according to a radio resource control configuration received from a base station;
discarding the first PDCP SDU after the discard timer has expired and determining whether the second parameter is the same as the first parameter; and
in response to the second parameter being the same as the first parameter, discarding the second PDCP SDU.

2. The method according to claim 1, wherein the first parameter comprises a multi-modal service identifier (MMSID).

3. The method according to claim 1, wherein the step of discarding the second PDCP SDU comprises:
receiving a PDCP SDU discard indication based on a multi-modal service identifier (MMSID) from the base station,
wherein the PDCP SDU discard indication based on the MMSID is configured to indicate whether a PDCP SDU discard operation based on the MMSID for a PDCP SDU is activated.

4. The method according to claim 3, wherein the base station sends, by a medium access control (MAC) control element (CE), a bitmap of the PDCP SDU discard indication based on a MMSID to a user equipment (UE), wherein the bitmap of the PDCP SDU discard indication based on the MMSID indicates whether the PDCP SDU discard operation based on the MMSID for each of a plurality of Data Radio Bearers (DRBs) is activated or deactivated.

5. The method according to claim 3, wherein the base station sends, by a PDCP control Protocol Data Unit (PDU) or a Downlink Control Information (DCI), the PDCP SDU discard indication based on the MMSID to a user equipment (UE).

6. The method according to claim 1, wherein a first data radio bearer (DRB) of the first PDCP SDU and a second DRB of the second PDCP SDU are respectively corresponded to different PDCP entities of the user equipment.

7. The method according to claim 1, wherein a first data radio bearer (DRB) of the first PDCP SDU and a second DRB of the second PDCP SDU are respectively corresponded to the same PDCP entity of the user equipment.

8. The method according to claim 1, wherein the step of discarding the second PDCP SDU comprises:
checking whether pdu-SetDiscard is configured to the user equipment; and
in response to pdu-SetDiscard is configured to the user equipment, discarding the second PDCP SDU.

9. The method according to claim 1, wherein the step of discarding the second PDCP SDU comprises:
checking whether pdu-SetDiscardthreshold is configured to a user equipment and reached, wherein pdu-SetDiscardthreshold is a content ratio defined as a ratio of PDUs of a PDU Set, wherein the ratio is needed at the user equipment to reconstruct an original content; and
in response to pdu-SetDiscardthreshold is configured to the user equipment and reached, discarding the second PDCP SDU.

10. The method according to claim 1, wherein the step of discarding the second PDCP SDU comprises:
in response to an importance of the second parameter of the corresponding second PDCP SDU being low important, discarding the second PDCP SDU.

11. The method according to claim 10, further comprising:
receiving an indication of the importance of the second parameter of the corresponding second PDCP SDU from the base station; or
determining the importance of the second parameter of the corresponding second PDCP SDU at a PDCP entity.

12. The method according to claim 1, wherein the step of discarding the second PDCP SDU further comprises:
determining whether the first PDCP SDU and the second PDCP SDU belong to the same burst; and
in response to the first PDCP SDU and the second PDCP SDU belonging to the same burst, discarding the second PDCP SDU.

13. A user equipment, comprising:
a transceiver, receiving a radio resource control configuration from a base station; and
a processor, coupled to the transceiver and configured to:
obtain a plurality of packet data convergence protocol (PDCP) service data units (SDUs), wherein the plurality of PDCP SDUs comprises a first PDCP SDU corresponding to a first parameter and a second PDCP SDU corresponding to a second parameter,
set a discard timer for the first PDCP SDU according to the radio resource control configuration;
discard the first PDCP SDU after the discard timer has expired and determine whether the second parameter is the same as the first parameter; and
in response to the second parameter being the same as the first parameter, discard the second PDCP SDU.
